(19) United States
(12) Patent Application Publication
(10) Pub. No.: US 2021/0031707 A1
(43) Pub. Date: Feb. 4, 2021

(54) Electrically Conducting Textile for Automobiles

(71) Applicant: Lydall, Inc., Manchester, CT (US)

(72) Inventor: Cody Williams BROWN, State Road, NC (US)

(21) Appl. No.: 16/945,193

(22) Filed: Jul. 31, 2020

Related U.S. Application Data
(60) Provisional application No. 62/881,981, filed on Aug. 2, 2019.

(51) Int. Cl. B60R 13/02; H01B 1/02; B60R 16/02; B32B 5/02; B32B 5/06; B32B 5/26; B32B 5/12

(52) U.S. Cl. CPC B60R 13/02; H01B 1/02; B60R 16/02; B32B 5/022; H02J 50/00; B32B 5/024; B32B 5/06; B32B 5/26; B32B 5/12; B32B 5/026

(57) ABSTRACT

An automotive panel includes a first layer having a fibrous portion. The first layer additionally includes an electrically conductive thread sewn into the fibrous portion. The sewn electrically conductive thread forms a circuit configured to deliver current from a power source. A second layer overlaps the first layer. At least one of the conductive thread or the fibrous portion includes materials having suitable properties to allow for die cutting or thermoforming the automotive panel without damaging the fibrous portion or disrupting the continuity of the circuit formed by the conductive thread.

### CROSS-REFERENCE TO RELATED APPLICATIONS

This application claims benefit to the priority under 35 U.S.C. § 119 from U.S. Provisional Application No. 62/881,981, the entire disclosure of which is herein expressly incorporated by reference.

### BACKGROUND AND SUMMARY OF THE INVENTION

Modern automobiles may contain a large number of electrical components of various types including, for example, lighting elements, sensors, environmental components, entertainment, navigation, and many more. Electrical components may be found in essentially every portion of the interior, i.e., passenger compartment, of an automobile. Further, based at least on the increased adoption of electric vehicles, the number and types of electrical components seem likely to increase in the years to come.

Every electrical component in an automobile may be connected to the electrical system, which includes the automobile's power source. These connections may be entirely achieved with electrical wiring. The large number of electrical components may result in a large number of electrical wires and the wide ranging placement of electrical components may result in many wires extending in numerous directions. The large number and vast distribution of wires may be managed with the use of wiring harnesses.

Other than windows, the body structure of an automobile interior typically may be defined by a set of panels, often padded, insulated, and typically covered with fabric, leather and synthetic leather upholstery. The roof panel covering may be typically referred to as a headliner. The floor of an automobile interior usually may be a form of heavy duty carpeting. The panels and carpeting may serve the purpose, among others, of retaining the many wires and harnesses in a place inaccessible to the occupants of the automobile. The panels and carpeting may also serve the purpose of providing a mounting/supporting point for many electrical components. The wiring harnesses mentioned above may be glued or otherwise attached to the interior panels and guide the wires along their designated paths. Less complicated structures than wiring harnesses may also be used to guide the wires, e.g., clips. Wiring harnesses, clips or other elements may be glued directly to the interior panel and, sometimes, the wires themselves may be glued to the panels.

Taking as an example an automobile headliner panel, electrical components may be mounted within and on a headliner at multiple points as well as around the periphery thereof. Multiple wires from the power source, such as a battery or battery pack, connected to a positive terminal thereof, may be guided through structural portions of the automobile to the headliner and may then be guided by wiring harnesses or similar elements. The large number of wires may be divided into smaller wire sets and guided to various portions of the headliner until a single wire is connected to its designated electrical component on the headliner. A separate wire connected to the electrical component may be connected to ground, which is typically the electrically conducting body of the automobile that shares a connection to a negative terminal of the power source. The “ground wire” may be paired with the power source wire when routed through the vehicle, though it need not follow it all the way back to the power source. Rather the ground wire may only proceed far enough to be connected to the vehicle body, as previously indicated. In a typical headliner, the number of components integrated therewith results in a very complicated set of wires, wiring harnesses and other guiding elements distributing the complicated set of wires across the entirety of the headliner.

Connecting the power source wire and the earth wire to each electrical component mounted in or on the headliner of an automobile and then routing those wires through the several wiring harnesses, or similar element, to one or more wiring harnesses servicing the headliner is a time consuming task. It is a task that must also be performed with precision for every headliner assembled. Further, the headliner is only one of a number of electrical component bearing elements of an automobile.

The present subject matter may dispense with at least a portion of the large number of wires, wiring harnesses and similar elements associated with an automobile part such as a headliner. The present subject matter may integrate as many of these elements as possible into a single part, i.e., the headliner. Ideally, if all of the wires were integrated to the headliner, it may be possible that all of the electrical components on or in the headliner could be connected to the electrical system and power source of the automobile through a single electrical connection point.

An integrated electrical connection system would also permit, with parts such as flooring, new opportunities to integrate components such as heating elements, which were not previously achievable.

An integrated automobile part would solve various problems. Such a part would result in a substantial reduction of installation time and reduction in erroneous wiring issues. Substantial reduction in wiring materials may also result from such an integrated automobile part.

The presently utilized wiring system also results in the use of electrical components in additional areas of an automobile interior being cost prohibitive. For example, bringing illumination to some interior portions of an automobile, such as storage compartments and map pockets, would be beneficial but not worth an additional wiring harness and other factors. A panel, pocket or other automobile part with an integrated electrical connection system would overcome this cost prohibitive issue and permit illumination to be brought to appropriate areas in a cost-effective manner. Similarly, the cost savings of an integrated electrical part opens the door to embedded components that can provide value and add functionality to a various array of parts throughout the vehicle's interior and exterior. Original equipment manufacturers (“OEMs”) often avoid designing components in hard to reach areas of an automobile all together in order to avoid having to route the wires and harnesses to such areas.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description explain the principles of embodiments of the disclosed subject matter. No attempt is made to show structural details in more detail than may be necessary for a fundamental understanding of the disclosed subject matter and various ways in which it may be practiced.

FIG. 1 is a diagram of an example vehicle panel connected with a power source and configured to deliver power via an electrically conductive thread according to an embodiment of the disclosed subject matter.

FIG. 2 is an example vehicle panel having an electrically conductive thread stitched to a fibrous material according to an embodiment of the disclosed subject matter.

FIG. 3 is an example vehicle panel having an electrically conductive thread stitched to a fibrous material and formed into a three-dimensional product according to an embodiment of the disclosed subject matter.

FIG. 4A is an example vehicle panel having an electrically conductive thread stitched and routed so as to provide radiant heat according to an embodiment of the disclosed subject matter.

FIG. 4B is a photo captured by an infrared camera to show a thermal signature of the vehicle panel of FIG. 4A when powered according to an embodiment of the disclosed subject matter.

### DETAILED DESCRIPTION

Reference will now be made in detail to various embodiments. Each example may be provided by way of explanation and is not meant as a limitation and does not constitute a definition of all possible embodiments.

The exemplary devices, systems, and methods disclosed herein may be encompassing with many opportunities particularly in the automotive sector but also including, without limitation, comparable industrial applications. The present subject matter describes an electrically conductive thread that may be sewn, attached to, or integrated into a die cut two-dimensional (2-D) or molded three-dimensional (3-D) fibrous part. The electrically conductive thread may be any known conductive thread consistent with this disclosure without departing from the scope of the disclosed subject matter. As used herein, “electrically conductive,” in the context of the automotive environment disclosed is understood to mean that the “electrically conductive” component should conduct a measureable and significant amount of electrical current when a voltage of an automotive electrical system is applied to the component. For example, for a thread to be considered “electrically conductive,” it should be possible to convey sufficient current at a voltage level of a conventional vehicle electrical system to power an electrical component to an operable state.

Many automobile panels and/or portions of panels may be formed from fibrous elements that have electrical components integrated into the core of the material in accordance with the present subject matter. The fibrous portion may be a nonwoven, thermal bonded, needle punched, spunlace, knit, or a woven material, or may be a combination of these processes. The fibrous material used in constructing the panels may include polyester, polypropylene, nylon, fiberglass, and rayon, though a great number of material choices exist. Importantly, the fibrous portion and electrically conductive thread, when sewn into the fibrous portion, may be comprised of materials having sufficient stretch or elasticity to allow for subsequently cutting using a 2-D die cutting process or a 3-D forming process that utilizes heat and pressure, such as thermoforming. While the a variety of suitable materials may be selected for the electrically conductive thread and fibrous portion, the materials must be critically capable of withstanding the subsequent processes in order to prevent damage of the sewn thread, which would diminish or even destroy the current-carrying capabilities of the electrically conductive thread. The materials disclosed herein are provided as an example and may be preferably selected with this constraint in mind.

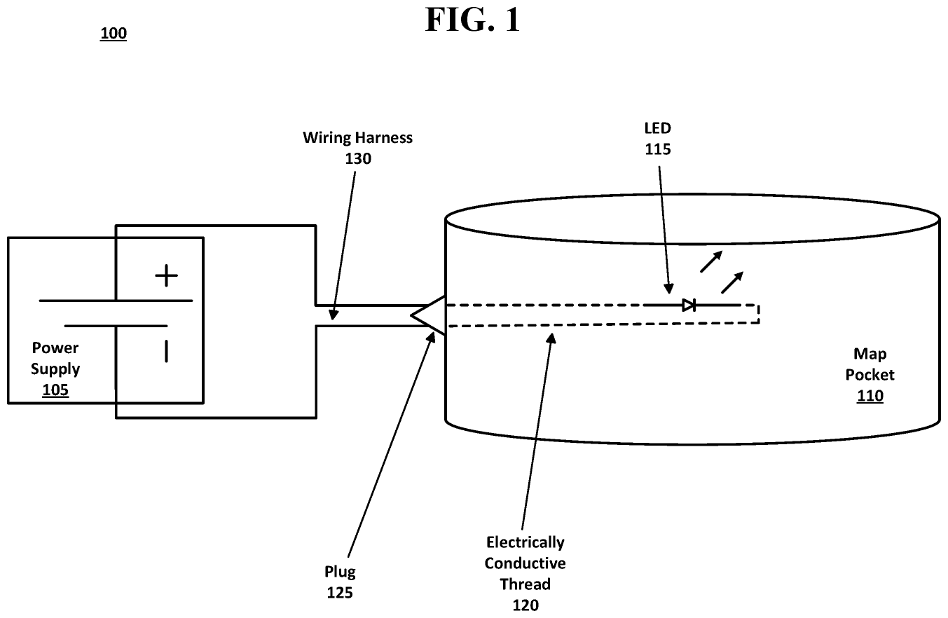

FIG. 1 illustrates a schematic 100 of an example door map pocket 110 that may be installed within an automobile, airplane, boat, or other vehicle. The map pocket 110 may be composed of a fibrous material in which an electrically conductive thread 120 may be sewn. An advantage of incorporating the electrically conductive thread 120 within the map pocket 110 may be the capability to power low-power devices, such as a light-emitting diode (LED) 115. The LED 115 may be used to illuminate the map pocket 110 itself or surrounding areas within a vehicle. Power may be supplied via a vehicle power supply 105. The power supply 105 may be of the alternating current (AC) or direct current (DC) types, for example. Power may be delivered from the power supply 105 to the electrically conductive thread 120 of the map pocket 110 via wires or a wiring harness 130. The wires or wiring harness 130 may be terminated via a plug 125, or other connection means. In an embodiment, power may be delivered from power supply 105 to the map pocket 110 and LED 115 via wireless power transmission that utilizes an inductive coil (not illustrated), for example.

An automotive panel 200/300/400 produced in accordance with the present subject matter may include one or more layers. The layers may be designated, for example, as an “A-layer” or “B-layer.” The B-layer, for purposes of discussion of the present subject matter, may be the layer upon which the electrically conductive thread 120/220/320/420 is sewn. The A-layer may be disposed on top of the B-layer so as to cover and protect the conductive thread 320 from abrasion and damage, to conceal the electrically conductive thread 320, and/or to insulate the electrically conductive thread 120/220/320/420. In any case, it remains important that the electrically conductive thread 320 be composed of materials that are capable of sustaining the sewing process and of a gauge that may pass through the associated sewing needle head. Alternatively, or in addition, the B-layer may be covered by one or more A-layers on one or both sides of the B-layer. The B-layer alone or, more typically, both the B-layer and A-layer together may be the primary step that creates the core component of the structural automobile panel, such as a headliner or map pocket. Other examples of such structural automobile parts include wheel arch liners, flooring pads, interior close-outs, hush panels, and the like. The A-layer may be joined to the B-layer via sewing, lamination via adhesives, lamination via heat and pressure, mechanical fasteners, and the like. The A-layer need not be composed of the same material as the B-layer, as long as they are capable of being joined using one of the methods previously described.

In addition to the A-layer and B-layer, a non-woven decoupling insulator may also be incorporated as a layer of the automotive panel. The non-woven decoupling insulator may be formed from a felt or felt-like material and may be applied between the A-layer and the B-layer and/or provided behind the B-layer against a vehicle surface having an acoustic requirement. The non-woven decoupling insulator layer may be useful to reduce noise in a floor or ceiling panel or covering, for example. The non-woven decoupling insulator may be applied on the back side of a heated covering or furnishing.

Products developed in accordance with the present subject matter may be manufactured through a series of steps. The nonwoven decoupling insulator may be produced on either a thermally-bonded HiLoft line or a needle-punched card or cross-lapped production line. An electrically conductive thread may be sewn into a fibrous material at a sewing facility. The fibrous material having the sewn-in electrically conductive thread may then be provided to a 2-D die cutting or 3-D molding, such as thermoforming, followed by assembly of any components, connectors, fasteners, or the like that needed for the application.

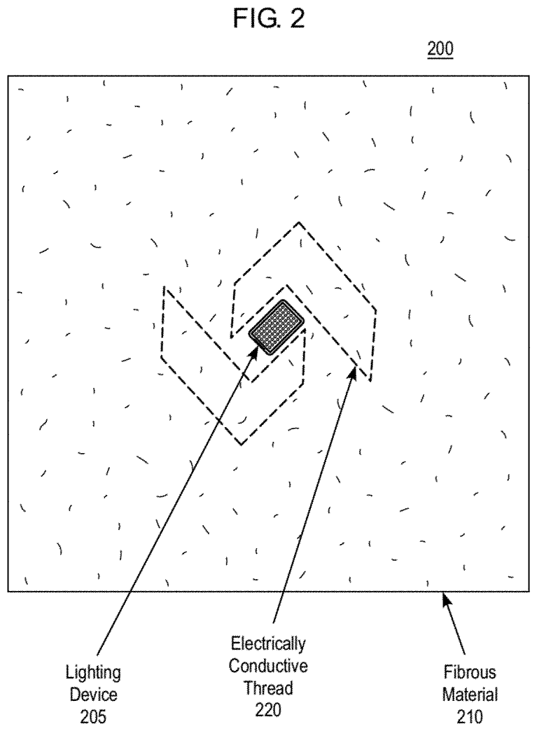

FIG. 2 illustrates an example of an automotive panel 200 that may include a lighting device 205 attached to a fibrous material 210 and connected to a power source via electrically conductive thread 220. The panel 200 may be subsequently subjected to a 3-D molding process or a 2-D die cutting process after integrating the fibrous material 210 with the electrically conductive thread 220 via sewing. Low power electronic devices configured to utilize power supplied via conductive thread 220, such as lighting device 205, may be added before or after the 2-D die cutting or 3-D molding process, depending on the type of device and the likelihood of damaging the device during the associated processes. Preferably, relatively inflexible electronic components, such as LEDs, modules, processors, microcontrollers, speakers, and the like, are added following the 2-D cutting and/or 3-D molding processes.

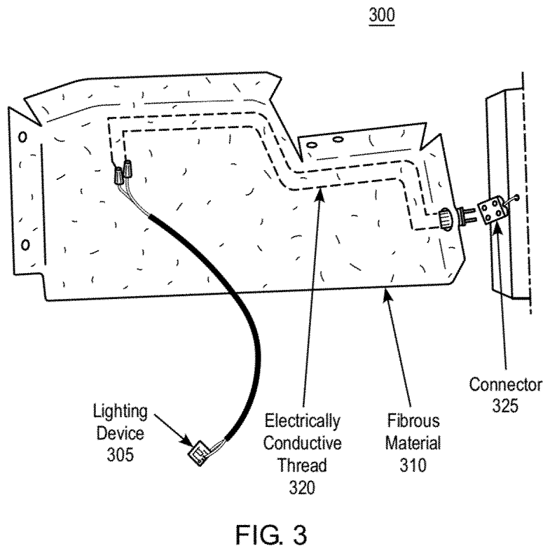

FIG. 3 illustrates an example of an automotive panel 300, which may be utilized in furnishing a vehicle interior. The automotive panel 300 may include a lighting device 305 attached to a fibrous material 310 and connected to a power source via electrically conductive thread 320 and connector 325, a plug, or equivalent. In the example of FIG. 3, the automotive panel 300 has been subsequently processed by at least one or more of a 2-D die cutting or 3-D molding process, such as thermoforming. The automotive panel 300 may exhibits the stitched electrically conductive thread 320 on the visible layer, which may indicate that this is the B-layer, as previously discussed. Accordingly, should this B-layer may be visible or in close proximity to prospective occupants of the automobile, one or more A-layers, or even a non-woven insulating layer, may be laminated to the B-layer shown.

In practice, the lighting device 305 located at the end of the visible wire may be integrated with the fibrous material 310 and electrically connected to the electrically conductive thread 320. A battery-based power source may be electrically connected with connector 325 to deliver power to the lighting device 305. The connection of, for example, an automobile power source to the lighting device 305 may be a plug as shown in FIG. 3 or other type of connector capable of delivering power, or may even be achieved using corresponding inductive coils for wireless delivery of power. For instance, the electrically conductive thread 320 may be stitched in a closely-spaced ring pattern such that an inductive coil is formed on the fibrous material 310 to receive power transmitted inductively from a power source.

The present subject matter may be used in the automotive industry with electrical components such as interior lighting, heating, sensors, buttons/switches, entertainment devices, Bluetooth devices, or any other component requiring electrical current for operation. For instance, ambient lighting, when integrated into fibrous parts around the foot well, map pockets, glove boxes and rear closeouts of SUVs. This may be accomplished using a thread made of conductive materials such as steel, silver coated fibers, non-conductive fibers with electrically conductive coatings, aluminum, copper, etc. This thread may be comprised of many fine fibers and of a gauge that make it compatible with available sewing machine technology. Therefore, the electrically conductive thread may be directly stitched into parts before or even after molding, depending on the part geometry.

A goal of the present subject matter may be to facilitate installation of electrical and electronic components by the OEM. That is, the automotive panel may be supplied to the OEM and may be installed merely by connecting one or several electrical connectors from the vehicle to the part, resulting in the elimination of much of the conventional wiring and wiring harnesses. This elimination of wiring and wiring harnesses may result in a substantial savings of time and cost for the OEM. In addition, the present subject matter allows for electrification in areas of the vehicle that may not have been feasible in the past due to space, appearance, or serviceability constraints, for example.

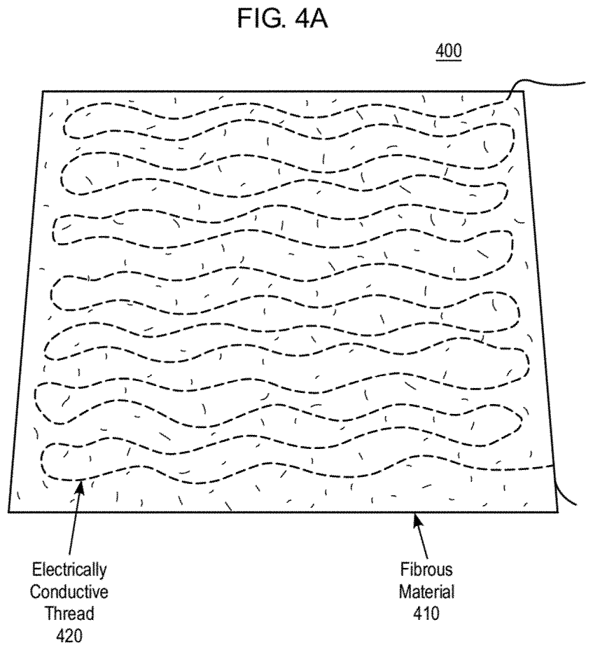

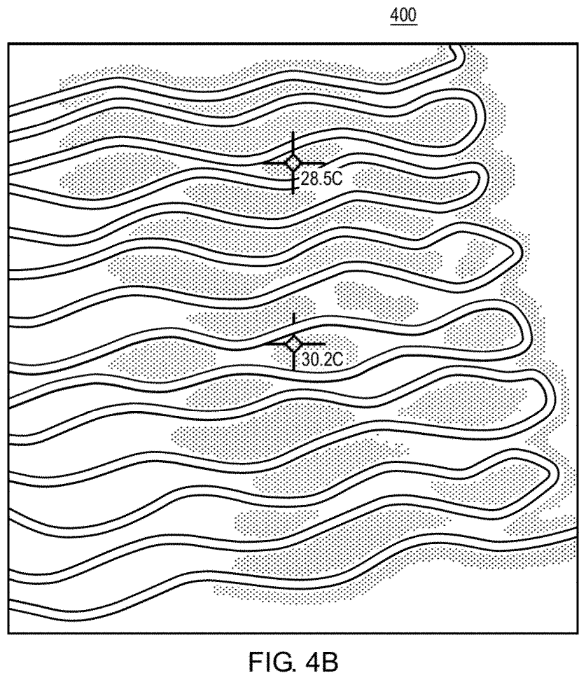

Embodiments of an electrically conducting textile as described throughout this disclosure allow for such providing electrical power in various areas of a vehicle. For example, a conductive thread with moderate resistance may be sewn into a flooring product. FIG. 4A illustrates an example vehicle panel 400 including fibrous material 410, such as a vehicle carpet or seat, having an electrically conductive thread 420 sewn to it. Applying a voltage and/or current to the electrically conductive thread 420 may cause the electrically conductive thread 420 to begin radiating heat and to conduct heat into the attached fibrous material 410. This may be useful to provide heat to the passengers, to provide heat to temperature-sensitive vehicle components, as well as to aid in subsidizing the heat from convective blowers of the vehicle. In FIG. 4A, the electrically conductive thread 420 may be sewn into the B-surface layer, which may be composed of a thermoplastic polyolefin, thermoplastic polyurethane, or similar material, and may be laminated and/or embedded into the flooring product. FIG. 4B illustrates the result of photographing the vehicle panel 400 of FIG. 4A using an infrared camera to capture the associated thermal signature and associated temperatures.

A secondary step may be to integrate the electrically conductive thread 420 to yield an “ETextile.” The sewn electrically conductive thread 420 may be the “circuit” of the product that may be used to pass current. A third step may be common to today's process which “shapes” the product into its final form through, e.g., 2-D die-cutting and/or 3-D molding. The electrically conductive thread 420 being mechanically fastened within the part, via sewing for example, before the final forming process may be an important factor in producing the part. In contrast, conventional techniques for integrating the electrically conductive thread into the fibrous material and the associated electrical components would be exponentially more difficult, if even possible to sew the electrically conductive thread into the part following the forming process. In a fourth step, electrical components such as LED lights, switches, sensors, clips, screws, heating elements, etc., may be attached to the part and electrically connected to the electrically conductive threads. The thread may be sewn into the B-layer surface and subsequently covered by the A-layer surface. In an example, the electrically conductive thread may be encapsulated within one or more layers of the panel product and may not visible to the user. This also protects the circuit from any additional wear and tear, liquid spills, and the like that the B-layer surface may see, thereby preventing premature short-circuiting, reduced electrical conductivity, or other failures. Attaching the A-layer to the B-layer can take place between or after several of these steps, and may be attached via sewing, lamination via adhesives, lamination via heat and pressure, mechanical fasteners, and the like.

One part or panel with numerous electrical components may be the headliner in an automobile. Such electrical components may include Bluetooth modules, lighting, garage door remotes, microphones, speakers, rear thermostat controls, entertainment units, sensors, etc., all with power delivered to them via the electrically conductive thread. The headliner panel itself may be a multi-layered product and may be amenable to having a conductive B-layer inserted as one of the multiple layers. It may forego the need to have the electrically conductive thread. For instance, if an electrically conductive staple fiber was used in a lightweight needle punch, the entire panel could be utilized to deliver power to one or more electrical devices.

The present structure and process may not be limited to automobile or vehicle parts and its advantages may be realized in other molded product contexts. For example, the present subject matter could be applied to interior panels used for decorative design which provide acoustic damping for workplace or home use. LED ambient lighting could be implemented on the A-surface providing various colors or fading tones for environmental aesthetics in such panels. The panel could be developed as an acoustic panel and a zero-footprint lamp which could increase its marketability and functionality.

An important factor in the present subject matter may be that the core fibrous material used for the structural aspect of the product may preferably be penetrable by a needle of a sewing machine. More particularly, a layer of the part, i.e., the B-layer, may preferably be amenable to having an electrically conductive thread incorporated therein through the use of a sewing machine. Further, the conductive circuit provided using the electrically conductive thread must be able to safely conduct the currents at the voltage levels conventionally used in electric, and hybrid automobiles. Any circuits to be used for heating applications may not exceed due to OEM restrictions. Example materials for the conductive thread include steel, silver coated fibers, non-conductive fibers with coatings, aluminum, etc.

This disclosure, in various embodiments, configurations and aspects, includes components, methods, processes, systems, and/or apparatuses as depicted and described herein, including various embodiments, sub-combinations, and subsets thereof. This disclosure contemplates, in various embodiments, configurations and aspects, the actual or optional use or inclusion of, e.g., components or processes as may be well-known or understood in the art and consistent with this disclosure though not depicted and/or described herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges may be inclusive of all sub-ranges therebetween. It is to be expected that the appended claims should cover variations in the ranges except where this disclosure makes clear the use of a particular range in certain embodiments.

This disclosure is presented for purposes of illustration and description. This disclosure is not limited to the form or forms disclosed herein. In the Detailed Description of this disclosure, for example, various features of some exemplary embodiments may be grouped together to representatively describe those and other contemplated embodiments, configurations, and aspects, to the extent that including in this disclosure a description of every potential embodiment, variant, and combination of features is not feasible. Thus, the features of the disclosed embodiments, configurations, and aspects may be combined in alternate embodiments, configurations, and aspects not expressly discussed above. For example, the features recited in the following claims lie in less than all features of a single disclosed embodiment, configuration, or aspect. Thus, the following claims may be hereby incorporated into this Detailed Description, with each claim standing on its own as a separate embodiment of this disclosure.

Advances in science and technology may provide variations that may not necessarily be expressed in the terminology of this disclosure although the claims would not necessarily exclude these variations.

Implementations disclosed herein can include components, arrangements, techniques, and compositions, such as the following.

1. An automotive panel, comprising:

a first layer comprising:
a fibrous portion; and
an electrically conductive thread sewn into the fibrous portion and forming a circuit configured to deliver current from a power source; and

a second layer overlapping the first layer, wherein
at least one of the conductive thread or the fibrous portion comprises materials having suitable properties to allow for die cutting or thermoforming the automotive panel without damaging the fibrous portion or disrupting the continuity of the circuit formed by the conductive thread.

2. The automotive panel of implementation 1, wherein

the fibrous portion comprises at least one selected from the group consisting of:
nonwoven material;
thermal bonded material;
needle punched material;
spunlace material;
knit material; or
woven material;

3. The automotive panel of implementations 1 or 2, wherein

the electrically conductive thread is composed from at least one of:
steel;
silver coated fibers;
non-conductive fibers with electrically conductive coatings;
aluminum; or
copper.

4. The automotive panel of any one of the preceding implementations, wherein
the electrically conductive thread is configured to provide radiant heat when connected to the power source.

5. The automotive panel of any one of the preceding implementations, wherein
the radiant heat to be provided is electrically limited to 60° C. or less.

6. The automotive panel of any one of the preceding implementations, wherein
the second layer conceals the electrically conductive thread.

7. The automotive panel of any one of the preceding implementations, wherein
the electrically conductive thread comprises at least one material capable of being sewn in a sewing machine and of a gauge that allows for insertion into a head of a sewing needle.

8. The automotive panel of any one of the preceding implementations, further comprising:
a non-woven decoupling insulator layer attached to at least one of the first layer or the second layer.

9. The automotive panel of any one of the preceding implementations, wherein
the non-woven decoupling insulator layer comprises a felt or felt-like material.

10. The automotive panel of any one of the preceding implementations, wherein
the first layer is composed from at least one of:
   polyester;
   thermoplastic polypropylene;
   thermoplastic polyolefin;
   nylon;
   fiberglass; or
   rayon.

11. The automotive panel of any one of the preceding implementations, wherein
the first layer and the second layer are joined via a laminating process.

12. The automotive panel of any one of the preceding implementations, wherein
the non-woven decoupling insulator layer is disposed between the first layer and the second layer.

13. The automotive panel of any one of the preceding implementations, wherein
the power source applies a voltage to the circuit via wireless power transfer.

14. The automotive panel of any one of the preceding implementations, wherein
the electrically conductive thread comprises a plurality of electrically conductive fibers.

What is claimed is:

1. An automotive panel, comprising:
a first layer comprising:
a fibrous portion; and
an electrically conductive thread sewn into the fibrous portion and forming a circuit configured to deliver current from a power source; and
a second layer overlapping the first layer, wherein
at least one of the conductive thread or the fibrous portion comprises materials having suitable properties to allow for die cutting or thermoforming the automotive panel without damaging the fibrous portion or disrupting the continuity of the circuit formed by the conductive thread.

2. The automotive panel of claim 1, wherein
the fibrous portion comprises at least one selected from the group consisting of:
nonwoven material;
thermal bonded material;
needle punched material;
spunlace material;
knit material; or
woven material;

3. The automotive panel of claim 1, wherein
the electrically conductive thread is composed from at least one of:
steel;
silver coated fibers;
non-conductive fibers with electrically conductive coatings;
aluminum; or
copper.

4. The automotive panel of claim 1, wherein
the electrically conductive thread is configured to provide radiant heat when connected to the power source.

5. The automotive panel of claim 4, wherein
the radiant heat to be provided is electrically limited to 60° C. or less.

6. The automotive panel of claim 1, wherein
the second layer conceals the electrically conductive thread.

7. The automotive panel of claim 1, wherein
the electrically conductive thread comprises at least one material capable of being sewn in a sewing machine and of a gauge that allows for insertion into a head of a sewing needle.

8. The automotive panel of claim 1, further comprising:
a non-woven decoupling insulator layer attached to at least one of the first layer or the second layer.

9. The automotive panel of claim 8, wherein
the non-woven decoupling insulator layer comprises a felt or felt-like material.

10. The automotive panel of claim 1, wherein
the first layer is composed from at least one of:
polyester;
thermoplastic polypropylene;
thermoplastic polyolefin;
nylon;
fiberglass; or
rayon.

11. The automotive panel of claim 1, wherein
the first layer and the second layer are joined via a laminating process.

12. The automotive panel of claim 8, wherein
the non-woven decoupling insulator layer is disposed between the first layer and the second layer.

13. The automotive panel of claim 1, wherein
the power source applies a voltage to the circuit via wireless power transfer.

14. The automotive panel of claim 1, wherein
the electrically conductive thread comprises a plurality of electrically conductive fibers.
